(19) United States
(12) Patent Application Publication
(10) Pub. No.: US 2013/0106117 A1
(43) Pub. Date: May 2, 2013

(54) Low Emission Heating of A Hydrocarbon Formation

(71) Applicant: Omar Angus Sites, Spring, TX (US)

(72) Inventor: Omar Angus Sites, Spring, TX (US)

(21) Appl. No.: 13/648,115

(22) Filed: Oct. 9, 2012

Related U.S. Application Data
(60) Provisional application No. 61/551,697, filed on Oct. 26, 2011.

(51) Int. Cl. E21B 43/24; H02K 7/18; E21B 43/34; E21B 43/16; B65G 5/00

(52) U.S. Cl. 290/1 R; 166/302; 166/265; 405/129.35; 166/272.1; 166/52

(57) ABSTRACT

A method for in situ heating of a subsurface formation is provided. The method includes receiving hydrocarbon fluids produced from the subsurface formation as a result of heating. The method also includes processing the produced fluids to generate a hydrocarbon stream. A portion of the hydrocarbon stream is then delivered to a combustor along with an oxygen-containing stream as a combustion mixture. A diluent gas stream may also be provided for cooling. The mixture is then combusted to generate electricity, and to release an exhaust stream comprising carbon dioxide. The method also includes using at least a portion of the exhaust gas stream generated from the combustion for injection or for sequestration, thereby minimizing atmospheric release. In addition, at least a portion of the electrical power is delivered to a plurality of electrically resistive heating elements to deliver heat to the subsurface formation. A low emission power generation system is also provided.

### CROSS-REFERENCE TO RELATED APPLICATION

This application claims the priority benefit of U.S. Provisional Patent Application 61/551,697 filed Oct. 26, 2011 entitled LOW EMISSION HEATING OF A HYDROCARBON FORMATION, the entirety of which is incorporated by reference herein.

### FIELD OF THE INVENTION

The present invention relates to the field of hydrocarbon recovery from subsurface formations. More specifically, the present invention relates to the in situ recovery of hydrocarbon fluids from organic-rich rock formations including, for example, oil shale formations and tar sands formations. The present invention also relates to low emission power generation for the heating of organic-rich rock.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Certain geological formations are known to contain an organic matter known as “kerogen.” Kerogen is a solid, carbonaceous material. When kerogen is imbedded in rock formations, the mixture is referred to as oil shale. This is true whether or not the mineral is, in fact, technically shale, that is, a rock formed from compacted clay.

Kerogen is subject to decomposing upon exposure to heat over a period of time. Upon heating, kerogen molecularly decomposes to produce oil, gas, and carbonaceous coke. Small amounts of water may also be generated. The oil, gas and water fluids become mobile within the rock matrix, while the carbonaceous coke remains essentially immobile.

Oil shale formations are found in various areas world-wide, including the United States. Such formations are notably found in Wyoming, Colorado, and Utah. Oil shale formations tend to reside at relatively shallow depths and are often characterized by limited permeability. Some consider oil shale formations to be hydrocarbon deposits which have not yet experienced the years of heat and pressure thought to be required to create conventional oil and gas reserves.

The decomposition rate of kerogen to produce mobile hydrocarbons is temperature dependent. Temperatures generally in excess of 270° C. (518° F.) over the course of many months may be required for substantial conversion. At higher temperatures, substantial conversion may occur within shorter times. When kerogen is heated to the necessary temperature, chemical reactions break the larger molecules forming the solid kerogen into smaller molecules of oil and gas. The thermal conversion process is commonly referred to as “pyrolysis.”

FIG. 1 is a cross-sectional perspective view of an illustrative hydrocarbon development area 100. The hydrocarbon development area 100 is for the purpose of producing hydrocarbons for commercial sale. The hydrocarbon development area 100 has a surface 110. Preferably, the surface 110 is an earth surface on land. However, the surface 110 may be a seabed under a body of water, such as a lake or an ocean.

The hydrocarbon development area 100 also has a subsurface 120. The subsurface 120 includes various formations, including one or more near-surface formations 122, a hydrocarbon-bearing formation 124, and one or more non-hydrocarbon formations 126. The near surface formations 122 represent an overburden, while the non-hydrocarbon formations 126 represent an underburden. Both the one or more near-surface formations 122 and the non-hydrocarbon formations 126 will typically have various strata with different mineralogies therein.

The hydrocarbon development area 100 is for the purpose of producing hydrocarbon fluids from the hydrocarbon-bearing formation 124. The hydrocarbon-bearing formation 124 defines a rock matrix having hydrocarbons residing therein. The hydrocarbons may be solid hydrocarbons such as kerogen. Alternatively, the hydrocarbons may be viscous hydrocarbons such as heavy oil that do not readily flow at formation conditions. The hydrocarbon-bearing formation 124 may also contain, for example, tar sands that are too deep for economical open pit mining. Therefore, an enhanced hydrocarbon recovery method involving formation heating is desirable.

It is understood that the representative formation 124 may be any organic-rich rock formation, including a rock matrix containing kerogen, for example. In addition, the rock matrix making up the formation 124 may be permeable, semi-permeable or non-permeable. The present inventions are particularly advantageous in shale oil development areas initially having very limited or effectively no fluid permeability. For example, initial permeability may be less than 10 millidarcies.

The hydrocarbon-bearing formation 124 may be selected for development based on various factors. One such factor is the thickness of organic-rich rock layers or sections within the formation 124. Greater pay zone thickness may indicate a greater potential volumetric production of hydrocarbon fluids. Each of the hydrocarbon-containing layers within the formation 124 may have a thickness that varies depending on, for example, conditions under which the organic-rich rock layer was formed. Therefore, an organic-rich rock formation such as hydrocarbon-bearing formation 124 will typically be selected for treatment if that formation includes at least one hydrocarbon-containing section having a thickness sufficient for economical production of hydrocarbon fluids.

An organic-rich rock formation such as formation 124 may also be chosen if the thickness of several layers that are closely spaced together is sufficient for economical production of produced fluids. For example, an in situ conversion process for formation hydrocarbons may include selecting and treating a layer within an organic-rich rock formation having a thickness of greater than about 5 meters, 10 meters, 50 meters, or more. In this manner, heat losses (as a fraction of total injected heat) to layers formed above and below an organic-rich rock formation may be less than such heat losses from a thin layer of formation hydrocarbons. A process as described herein, however, may also include incidentally treating layers that may include layers substantially free of formation hydrocarbons or thin layers of formation hydrocarbons.

The richness of one or more sections in the hydrocarbon-bearing formation 124 may also be considered. For an oil shale formation, richness is generally a function of the kerogen content. The kerogen content of the oil shale formation may be ascertained from outcrop or core samples using a variety of data. Such data may include Total Organic Carbon content, hydrogen index, and modified Fischer Assay analyses. The Fischer Assay is a standard method which involves heating a sample of a hydrocarbon-containing-layer to approximately 500° C. in one hour, collecting fluids produced from the heated sample, and quantifying the amount of fluids produced.

An organic-rich rock formation such as formation 124 may be chosen for development based on the permeability or porosity of the formation matrix even if the thickness of the formation 124 is relatively thin. Subsurface permeability may also be assessed via rock samples, outcrops, or studies of ground water flow. An organic-rich rock formation may be rejected if there appears to be vertical continuity and connectivity with groundwater.

Other factors known to petroleum engineers may be taken into consideration when selecting a formation for development. Such factors include depth of the perceived pay zone, continuity of thickness, and other factors. For instance, the organic content or richness of rock within a formation will effect eventual volumetric production.

In order to access the hydrocarbon-bearing formation 124 and recover natural resources therefrom, a plurality of wellbores is formed. The wellbores are shown at 130, with some wellbores 130 being seen in cut-away and one being shown in phantom. The wellbores 130 extend from the surface 110 and into the formation 124.

Each of the wellbores 130 in FIG. 1 has either an up arrow or a down arrow associated with it. The up arrows indicate that the associated wellbore 130 is a production well, or producer. Some of these up arrows are indicated with a “P.” The production wells “P” produce hydrocarbon fluids from the hydrocarbon-bearing formation 124 to the surface 110. Reciprocally, the down arrows indicate that the associated wellbore 130 is a heat injection well, or a heater well. Some of these down arrows are indicated with an “I.” The heat injection wells “I” inject heat into the hydrocarbon-bearing formation 124. Heat injection may be accomplished in a number of ways known in the art, including using downhole or in situ electrically resistive heat sources.

In one aspect, the purpose for heating the organic-rich rock in the formation 124 is to pyrolyze at least a portion of solid formation hydrocarbons to create hydrocarbon fluids. The organic-rich rock in the formation 124 is heated to a temperature sufficient to pyrolyze at least a portion of the oil shale in order to convert the kerogen to hydrocarbon fluids. The resulting hydrocarbon liquids and gases may be refined into products which resemble common commercial petroleum products. Such liquid products include transportation fuels such as diesel, jet fuel and naphtha. Generated gases may include light alkanes, light alkenes, hydrogen, carbon dioxide, and carbon monoxide.

The solid formation hydrocarbons may be pyrolyzed in situ by raising the organic-rich rock in the formation 124, (or heated zones within the formation), to a pyrolyzation temperature. In certain embodiments, the temperature of the formation 124 may be slowly raised through the pyrolysis temperature range. For example, an in situ conversion process may include electrically heating at least a portion of the formation 124 to raise the average temperature of one or more sections above about 270° C. at a rate less than a selected amount (e.g., about 10° C., 5° C.; 3° C., or 1° C.) per day. In a further embodiment, the portion may be heated such that an average temperature of one or more selected zones over a one month period is between 270° C. and about 375° C. or, in some embodiments, between 300° C. and about 400° C.

The hydrocarbon-rich formation 124 may be heated such that a temperature within the formation reaches (at least) an initial pyrolyzation temperature, that is, a temperature at the lower end of the temperature range where pyrolyzation begins to occur, within three months of heating. The pyrolysis temperature range may vary depending on the types of formation hydrocarbons within the formation, the heating methodology, and the distribution of heating sources. For example, a pyrolysis temperature range may include temperatures between about 270° C. and 800° C. In one aspect, the bulk of a target zone of the formation 124 may be heated to between 300° C. and 600° C. within four months of heating.

For in situ operations, the heating and conversion process occurs over a lengthy period of time. In one aspect, the heating period is from three months to four or more years.

Conversion of oil shale into hydrocarbon fluids will create permeability in rocks in the formation 124 that were originally substantially impermeable. For example, permeability may increase due to formation of thermal fractures within a heated portion caused by application of heat. As the temperature of the heated formation 124 increases, water may be removed due to vaporization. The vaporized water may escape and/or be removed from the formation 124 through the production wells “P.” In addition, permeability of the formation 124 may also increase as a result of production of hydrocarbon fluids generated from pyrolysis of at least some of the formation hydrocarbons on a macroscopic scale. For example, pyrolyzing at least a portion of an organic-rich rock formation may increase permeability within a selected zone to about 1 millidarcy, alternatively, greater than about 10 millidarcies, 50 millidarcies, 100 millidarcies, 1 Darcy, 10 Darcies, 20 Darcies, or even greater than 50 Darcies.

It is understood that petroleum engineers will develop a strategy for the best depth and arrangement for the wellbores 130 depending upon anticipated reservoir characteristics, economic constraints, and work scheduling constraints. In addition, engineering staff will determine what wellbores “I” should be formed for initial formation heating.

In an alternative embodiment, the purpose for heating the rock in the formation 124 is to mobilize viscous hydrocarbons. The rock in the formation 124 is heated to a temperature sufficient to liquefy bitumen or other heavy hydrocarbons so that they flow to a production well “P.” The resulting hydrocarbon liquids and gases may be refined into products which resemble common commercial petroleum products, such as road paving and surface sealing products.

In the illustrative hydrocarbon development area 100, the wellbores 130 are arranged in rows. The production wells “P” are in rows, and the heat injection wells “I” are in adjacent rows. This is referred to in the industry as a “line drive” arrangement. However, other geometric arrangements may be used such as a 5-spot arrangement. The inventions disclosed herein are not limited to the arrangement of production wells “P” and heat injection wells “I” unless so stated in the claims.

In the arrangement of FIG. 1, each of the wellbores 130 is completed in the hydrocarbon-bearing formation 124. The completions may be either open-hole or cased-hole. The well completions for the production wells “P” may also include propped or unpropped hydraulic fractures emanating therefrom as a result of a hydraulic fracturing operation, or the formation of lateral boreholes (not shown).

The various wellbores 130 are presented as having been completed substantially vertically. However, it is understood that some or all of the wellbores 130, particularly for the production wells “P,” could deviate into an obtuse or even horizontal orientation.

In the view of FIG. 1, only eight wellbores 130 are shown for the heat injection wells “I.” Likewise, only twelve wellbores 130 are shown for the production wells “P.” However, it is understood that in an oil shale development project or in a heavy oil production operation, numerous additional wellbores 130 will be drilled. In addition, separate wellbores (not shown) may optionally be formed for water injection, formation freezing, and sensing or data collection.

The production wells “P” and the heat injection wells “I” are also arranged at a pre-determined spacing. In some embodiments, a well spacing of 15 to 25 feet is provided for the various wellbores 130. The claims disclosed below are not limited to the spacing of the production wells “P” or the heat injection wells “I” unless otherwise stated. In general, the wellbores 130 may be from about 10 feet up to even about 300 feet in separation.

Typically, the wellbores 130 are completed at shallow depths. Completion depths may range from 200 to 5,000 feet at true vertical depth. In some embodiments, an oil shale formation targeted for in situ pyrolysis is at a depth greater than 200 feet below the surface, or alternatively 400 feet below the surface. Alternatively, conversion and production occur at depths between 500 and 2,500 feet.

A production fluids processing facility 150 is also shown schematically in FIG. 1. The fluids processing facility 150 is designed to receive fluids produced from the organic-rich rock of the formation 124 and the production wells “P.” The produced fluids are transported to the fluids processing facility 150 through one or more pipelines or flow lines 152. The fluid processing facility 150 may include equipment suitable for receiving and separating oil, gas, and water produced from the heated formation 124. The fluids processing facility 150 may further include equipment for separating out dissolved water-soluble minerals and/or migratory contaminant species, including, for example, dissolved organic contaminants, metal contaminants, or ionic contaminants in the produced water recovered from the organic-rich rock formation 124.

FIG. 1 shows three exit lines 154, 156, and 158. The exit lines 154, 156, 158 carry fluids from the fluids processing facility 150. Exit line 154 carries oil; exit line 156 carries gas; and exit line 158 carries separated water. The water may be treated and, optionally, re-injected into the hydrocarbon-bearing formation 124 as steam for further enhanced hydrocarbon recovery. Alternatively, the water may be circulated through the hydrocarbon-bearing formation at the conclusion of the production process as part of a subsurface reclamation project.

As noted, in order to carry out the process described above in connection with FIG. 1, it is necessary to heat the subsurface formation 124. Various techniques have been proposed over the years to heat a subsurface formation to pyrolysis temperatures, such as through the circulation of hot fluids or the use of downhole combustion burners. Some of the heating techniques involve the application of heat in situ using electrical energy.

In 1947, U.S. Pat. No. 2,732,195 issued to Fredrik Ljungstrom. That patent, entitled “Method of Treating Oil Shale and Recovery of Oil and Other Mineral Products Therefrom,” proposed the application of heat at high temperatures to the oil shale formation in situ. The purpose of such in situ heating was to distill hydrocarbons and produce them to the surface.

Ljungstrom coined the phrase “heat supply channels” to describe bore holes drilled into the formation. The bore holes received electrical heating elements which transferred heat to the surrounding oil shale. Thus, the heat supply channels served as early heat injection wells. The electrical heating elements in the heat injection wells were placed within sand or cement or other heat-conductive material to permit the heat injection wells to transmit heat into the surrounding oil shale while substantially preventing the inflow of fluids. According to Ljungstrom, the subsurface “aggregate” was heated to between 500° C. and 1,000° C. in some applications.

Along with the heat injection wells, fluid producing wells were completed in near proximity to the heat injection wells. As kerogen was pyrolyzed upon heat conduction into the aggregate or rock matrix, the resulting oil and gas would be recovered through the adjacent production wells.

Additional patents have been disclosed relating to the use of electrical energy for heating a subsurface formation. Examples of such patents include:
U.S. Pat. No. 3,149,672 titled “Method and Apparatus for Electrical Heating of Oil-Bearing Formations;”
U.S. Pat. No. 3,620,300 titled “Method and Apparatus for Electrically Heating a Subsurface Formation;”
U.S. Pat. No. 4,567,945 titled “Electrode Well Method and Apparatus;”
U.S. Pat. No. 4,401,162 titled “In Situ Oil Shale Process;” and
U.S. Pat. No. 4,705,108 titled “Method for In Situ Heating of Hydrocarbonaceous Formations.”

Several patents have proposed running an electrical current through a subsurface formation between two or more wells. U.S. Pat. No. 3,642,066 titled “Electrical Method and Apparatus for the Recovery of Oil,” provides a description of resistive heating within a subterranean formation by running alternating current between different wells. U.S. Pat. No. 3,137,347 titled “In Situ Electrolinking of Oil Shale,” describes a method by which electric current is flowed through a fracture connecting two wells to get electric flow started in the bulk of the surrounding formation.

Another example is found in U.S. Pat. No. 7,331,385. The '385 patent is entitled “Methods of Treating a Subterranean Formation to Convert Organic Matter into Producible Hydrocarbons.” The '385 patent teaches the use of electrically conductive fractures to heat oil shale. According to the '385 patent, a heating element is constructed by forming wellbores in a formation, and then hydraulically fracturing the oil shale formation around the wellbores. The fractures are filled with an electrically conductive material which forms the heating element. Preferably, the fractures are created in a vertical orientation extending from horizontal wellbores. An electrical current is passed through the conductive fractures from about the heel to the toe of each well. To facilitate the current, an electrical circuit may be completed by an additional transverse horizontal well that intersects one or more of the vertical fractures. The process of U.S. Pat. No. 7,331,385 creates a resistive heater that artificially matures oil shale through the application of electric heat. Thermal conduction heats the oil shale to conversion temperatures in excess of about 280° C., causing artificial maturation.

Yet another example of electrical heating is disclosed in U.S. Patent Publ. No. 2008/0271885 published on Nov. 6, 2008. This publication is entitled “Granular Electrical Connections for In Situ Formation Heating.” In this publication, a resistive heater is formed by placing an electrically conductive granular material within a passage formed along a subsurface formation and proximate a stratum to be heated. In this disclosure, two or three wellbores are completed within the subsurface formation. Each wellbore includes an electrically conductive member. The electrically conductive member in each wellbore may be, for example, a metal rod, a metal bar, a metal pipe, a wire, or an insulated cable. The electrically conductive members extend into the stratum to be heated.

Passages are also formed in the stratum creating fluid communication between the wellbores. In some embodiments, the passage is an inter-connecting fracture; in other embodiments, the passage is one or more inter-connecting bores drilled through the formation. Electrically conductive granular material is then injected, deposited, or otherwise placed within the passages to provide electrical communication between the electrically conductive members of the adjacent wellbores.

In operation, a current is passed between the electrically conductive members. Passing current through the electrically conductive members and the intermediate granular material causes resistive heat to be generated primarily from the electrically conductive members within the wellbores. FIGS. 30A through 33 of U.S. Patent Publ. No. 2008/0271885 are instructive in this regard.

U.S. Patent Publ. No. 2008/0230219 describes other embodiments wherein the passage between adjacent wellbores is a drilled passage. In this manner, the lower ends of adjacent wellbores are in fluid communication. A conductive granular material is then injected, poured or otherwise placed in the passage such that granular material resides in both the wellbores and the drilled passage. In operation, a current is again passed through the electrically conductive members and the intermediate granular material to generate resistive heat. However, in U.S. Patent Publ. No. 2008/0230219, the resistive heat is generated primarily from the granular material. FIGS. 34A and 34B are instructive in this regard.

U.S. Patent Publ. No. 2008/0230219 also describes individual heater wells having two electrically conductive members therein. The electrically conductive members are placed in electrical communication by conductive granular material placed within the wellbore at the depth of a formation to be heated. Heating occurs primarily from the electrically conductive granular material within the individual wellbores. These embodiments are shown in FIGS. 30A, 31A, 32, and 33.

In one embodiment, the electrically conductive granular material is interspersed with slugs of highly conductive granular material in regions where no or minimal heating is desired. Materials with greater conductivity may include metal filings or shot; materials with lower conductivity may include quartz sand, ceramic particles, clays, gravel, or cement.

Co-owned U.S. Pat. Publ. No. 2010/0101793 is also instructive. That application was published on Apr. 29, 2010 and is entitled “Electrically Conductive Methods for Heating a Subsurface Formation to Convert Organic Matter into Hydrocarbon Fluids.” The published application teaches the use of two or more materials placed within an organic-rich rock formation and having varying properties of electrical resistance. Specifically, the granular material placed proximate the wellbore is highly conductive, while the granular material injected into a surrounding fracture is more resistive. An electrical current is passed through the granular material in the formation to generate resistive heat. The materials placed in situ provide for resistive heat without creating so-called hot spots near the wellbores.

Each of the above patents, including co-owned U.S. Pat. No. 7,331,385, U.S. Pat. Publ. No. 2010/0101793, and U.S. Patent Publ. No. 2008/0230219 provides a means for generating electrically resistive heat in situ. However, each requires the generation of considerable electrical power. Taking electrical power from a public grid or a private utility may be cost-prohibitive, or at least economically burdensome. Therefore, it is desirable to generate at least some of the power locally using hydrocarbon fluids such as methane produced from the formation 124.

The generation of electrical power using methane or other light hydrocarbon components involves the combustion and burning of fuel. It is desirable in such an operation to limit the emission of gases from the combustion process. Therefore, a need exists for a method of heating a subsurface formation using electrically resistive heating which provides low emissions of so-called greenhouse gases. Further, a need exists for a power generation system for electrically heating a subsurface formation that does not depend entirely upon a public electrical grid or a private utility, at least after start-up.

### SUMMARY OF THE INVENTION

The methods described herein have various benefits in improving the recovery of hydrocarbon fluids from an organic-rich rock formation such as a formation containing solid hydrocarbons or heavy hydrocarbons. In various embodiments, such benefits may include increased production of hydrocarbon fluids from an organic-rich rock formation, and providing a source of electrical energy for the recovery operation, such as for a shale oil production operation.

First, a method for in situ heating of a subsurface formation is provided. The subsurface formation comprises organic-rich rock. The organic-rich rock may include, for example, kerogen or bitumen.

The method includes receiving fluids produced from the subsurface formation.

The fluids include hydrocarbon fluids. The fluids may then be processed or separated to generate a hydrocarbon stream. A water stream may optionally also be created.

The method also includes delivering a portion of the hydrocarbon stream to a combustor. The combustor is located at a fossil fuel power plant. An oxygen-containing gas stream, or oxidant, is also directed into the combustor as an oxidant. The oxidant may be substantially pure oxygen generated from an air separation unit, or it may simply be air. A diluent gas stream is also directed to the combustor to reduce the temperature of the combustor and the exhaust stream. In either aspect, together the hydrocarbon stream and the oxygen-containing stream form a combustible mixture. The method then includes combusting at least a portion of the mixture in the combustor to generate electrical power.

In one aspect, the combustible mixture is fed into an expander. The expander may include a turbine which produces (i) mechanical power, and (ii) a lower-pressure gaseous exhaust stream comprised substantially of heated carbon dioxide and steam. Electricity is generated in response to the mechanical power of the expander.

The method may further include separating the hydrocarbon stream into a hydrocarbon liquid stream and a hydrocarbon gas stream. In this instance, combusting a portion of the hydrocarbon stream comprises combusting the hydrocarbon gas stream. The hydrocarbon gas stream will preferably include methane. A by-products gas stream may also be generated, comprising primarily carbon dioxide, nitrogen, and hydrogen sulfide, along with hydrogen and possibly carbon monoxide.

The method also includes using at least a portion of the gaseous exhaust stream from the expander for injection. This serves to minimize atmospheric release. Preferably, a substantial portion of the carbon dioxide from the exhaust stream is injected into the subsurface formation for enhanced hydrocarbon recovery. Alternatively, a substantial portion of the carbon dioxide or other gas comprises injecting the carbon dioxide into a separate subsurface zone for enhanced hydrocarbon recovery or sequestration.

In one aspect, the method includes separating at least a portion of the exhaust stream from the fossil fuel power plant into a rich carbon dioxide stream and a lean carbon dioxide stream. This is done in a carbon dioxide separation unit. Thereafter, at least a portion of the rich carbon dioxide rich stream is injected into the subsurface zone for enhanced hydrocarbon recovery, for sequestration, or for both, as part of the injecting step.

The method also includes using at least a portion of the electrical power generated from the expansion to a plurality of electrically resistive heating elements. This serves to deliver heat to the subsurface formation. The plurality of electrically resistive heating elements may represent, for example, metal rods, metal pipes, or electrically conductive proppants placed downhole.

Heating the subsurface formation generates hydrocarbon fluids in situ that can be further produced to the surface. Where the organic-rich rock formation comprises kerogen, heating the subsurface formation causes pyrolysis of the kerogen into hydrocarbon fluids. Where the organic-rich rock formation comprises bitumen or oil, heating the subsurface formation causes mobilization of the bitumen or oil into hydrocarbon fluids as the produced fluids. Where the organic-rich rock formation comprises bitumen, it is preferred that heating also takes place by delivering at least a portion of the steam from the gaseous exhaust stream into the subsurface formation.

In one embodiment, the method also includes cooling the heated carbon dioxide from the expander in a cooling unit, compressing the cooled carbon dioxide, and then injecting the carbon dioxide into a subsurface zone as the storing step. The subsurface zone may be the heated subsurface formation, in which case the carbon dioxide is used for enhanced hydrocarbon recovery. Alternatively, the subsurface zone is a separate subsurface formation provided for enhanced hydrocarbon recovery or sequestration.

In one embodiment, the hydrocarbon fluids are produced from wells at a hydrocarbon development area, and the combustor is remote from the hydrocarbon development area. In this instance, the method may further comprise generating the electrical power at a higher voltage for more efficient transmission to the hydrocarbon development area. The method may then also include transforming at least a portion of the transmitted electrical power up or down to a final voltage at the hydrocarbon development area for delivery to the one or more resistive heating elements. Alternatively, the method may further include distributing at least a portion of the transmitted electrical power directly to the one or more resistive heating elements without being directed through a transformer.

A low-emission power generation system is also provided herein. The system includes an organic-rich rock formation residing below an earth surface. The organic-rich rock may include, for example, kerogen or bitumen.

The system also includes a plurality of electrically resistive heating elements. The heating elements are located within the organic-rich rock formation. The plurality of electrically resistive heating elements may represent, for example, metal rods, metal pipes, or electrically conductive proppants placed downhole.

The system further includes a plurality of production wells. The production wells are configured to produce hydrocarbon fluids and deliver them to the earth surface.

The system also includes at least one hydrocarbon separation facility. The hydrocarbon fluids separation facility is configured to separate the produced hydrocarbon fluids into at least a hydrocarbon gas stream and a hydrocarbon liquids stream. The hydrocarbon fluids separation facility may also be configured to separate the gas stream into a fuel gas stream and a by-products gas stream. The fuel gas stream comprises methane.

The low-emission power generation system also includes a combustor. The combustor is configured to combust at least a portion of the hydrocarbon stream with an oxygen-containing stream. Together the hydrocarbon stream and the oxygen-containing stream form a combustion mixture.

The oxygen-containing stream may be substantially pure oxygen generated from an air separation unit. Alternatively, the oxygen-containing stream may be air. In either aspect, the combustor may also receive a diluent gas stream. The diluent gas stream may represent the by-products gas stream. The diluent gas stream helps to modulate the temperature of the combustor and an exhaust stream released by the combustor.

In one aspect, an air separation unit is provided to generate substantially pure oxygen as the oxidant. By-products such as nitrogen and carbon dioxide may be injected into a subsurface zone to avoid release into the atmosphere. A portion of the carbon dioxide may be used as the diluent gas stream.

The system further has an expander, which may include a turbine. The expander is configured to receive the gaseous combustion stream and produce mechanical power. The mechanical power turns a shaft for an electrical generator. The generator generates electricity in response to the mechanical power of the expander. The expander also outputs a gaseous exhaust stream comprised substantially of carbon dioxide and a water component, such as steam.

The system may also include a cooling system. The cooling system is configured to cool the gaseous exhaust stream and to separate any condensed liquids from the gaseous exhaust stream. Preferably, the cooling system is a heat recovery steam generator that is configured to cool the gaseous exhaust stream and boil water, and release heated steam and a cooled low-energy gas stream.

The system further includes a compressor. The compressor is configured to pressurize at least a portion of the cooled exhaust stream from the cooling system for delivery of at least a portion of the pressurized exhaust stream to a first injection system having one or more injection wells. The exhaust stream comprising carbon dioxide is then injected into a subsurface zone.

A separate compressor may be provided to receive at least a portion of the steam from the cooling system. Where a heat recovery steam generator is used, a portion of the generated steam may be taken. The steam may then be injected into the organic-rich rock formation to assist in formation heating.

Where a heat recovery steam generator is not used, the water-drop out from the cooling unit may be taken, and then treated. The water may be injected into the organic-rich rock formation as part of a water flood project, or released into the water shed.

The system also includes an electricity transmission system. The electricity transmission system is configured to distribute at least a portion of the electricity to the plurality of electrically resistive heating elements.

### BRIEF DESCRIPTION OF THE DRAWINGS

So that the present inventions can be better understood, certain drawings, charts, graphs and flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a three-dimensional isometric view of an illustrative hydrocarbon development area. The development area is for the production of hydrocarbon fluids from an organic-rich rock formation.

FIG. 2 is a schematic view of a system for low-emission power generation and hydrocarbon recovery of the present invention, in one embodiment. Two subsurface formations are shown in perspective, below the low-emission power generation system.

FIG. 3 is an enlarged schematic view of a portion of the low-emission power generation system of FIG. 2, but with additional optional features.

FIGS. 4A and 4B are a single flow chart of a method of operating the system of FIGS. 2 and 3. More specifically, FIG. 4 demonstrates steps for a method for in situ heating of a subsurface formation.

FIG. 5 is a flow chart showing steps for processing the gaseous exhaust stream output from the expander in the method of FIGS. 4A and 4B, in certain embodiments.

### DETAILED DESCRIPTION OF THE INVENTION

### Definitions

As used herein, the term “hydrocarbon” refers to an organic compound that includes primarily, if not exclusively, the elements hydrogen and carbon. Hydrocarbons may also include other elements, such as, but not limited to, halogens, metallic elements, nitrogen, oxygen, and/or sulfur. Examples of hydrocarbons include paraffins, cycloalkanes, aromatics, resins and asphaltenes. Examples of hydrocarbon-containing materials include any form of natural gas, oil, coal, and bitumen that can be used as a fuel or upgraded into a fuel.

As used herein, the term “hydrocarbon fluids” refers to a hydrocarbon or mixtures of hydrocarbons that are gases or liquids. For example, hydrocarbon fluids may include a hydrocarbon or mixtures of hydrocarbons that are gases or liquids at formation conditions, at processing conditions or at ambient conditions (15° C. and 1 atm pressure). Hydrocarbon fluids may include, for example, oil, natural gas, coalbed methane, shale oil, pyrolysis oil, pyrolysis gas, a pyrolysis product of coal, and other hydrocarbons that are in a gaseous or liquid state.

As used herein, the terms “produced fluids” and “production fluids” refer to liquids and/or gases removed from a subsurface formation, including, for example, an organic-rich rock formation. Produced fluids may include both hydrocarbon fluids and non-hydrocarbon fluids. Production fluids may include, but are not limited to, pyrolyzed shale oil, synthesis gas, a pyrolysis product of coal, carbon dioxide, hydrogen sulfide and water (including steam).

As used herein, the term “fluid” refers to gases, liquids, and combinations of gases and liquids, as well as to combinations of gases and solids, and combinations of liquids and solids.

As used herein, the term “gas” refers to a fluid that is in its vapor phase.

As used herein, the term “condensable hydrocarbons” means those hydrocarbons that condense to a liquid at about 15° C. and one atmosphere absolute pressure. Condensable hydrocarbons may include a mixture of hydrocarbons having carbon numbers greater than 3.

As used herein, the term “non-condensable” means those chemical species that do not condense to a liquid at about 15° C. and one atmosphere absolute pressure. Non-condensable species may include non-condensable hydrocarbons and non-condensable non-hydrocarbon species such as, for example, carbon dioxide, hydrogen, carbon monoxide, hydrogen sulfide, and nitrogen. Non-condensable hydrocarbons may include hydrocarbons having carbon numbers less than 4.

As used herein, the term “heavy hydrocarbons” refers to hydrocarbon fluids that are highly viscous at ambient conditions (15° C. and 1 atm pressure). Heavy hydrocarbons may include highly viscous hydrocarbon fluids such as heavy oil, tar, and/or asphalt. Heavy hydrocarbons may include carbon and hydrogen, as well as smaller concentrations of sulfur, oxygen, and nitrogen. Additional elements may also be present in heavy hydrocarbons in trace amounts. Heavy hydrocarbons may be classified by API gravity. Heavy hydrocarbons generally have an API gravity below about 20 degrees. Heavy oil, for example, generally has an API gravity of about 10 to 20 degrees, whereas tar generally has an API gravity below about 10 degrees. The viscosity of heavy hydrocarbons is generally greater than about 100 centipoise at about 15° C.

As used herein, the term “solid hydrocarbons” refers to any hydrocarbon material that is found naturally in substantially solid form at formation conditions. Non-limiting examples include kerogen, coal, shungites, asphaltites, and natural mineral waxes.

As used herein, the term “formation hydrocarbons” refers to both heavy hydrocarbons and solid hydrocarbons that are contained in an organic-rich rock formation. Formation hydrocarbons may be, but are not limited to, kerogen, oil shale, coal, bitumen, tar, natural mineral waxes, and asphaltites. A formation that contains formation hydrocarbons may be referred to as an “organic-rich rock.”

As used herein, the term “tar” refers to a viscous hydrocarbon that generally has a viscosity greater than about 10,000 centipoise at 15° C. The specific gravity of tar generally is greater than 1.000. Tar may have an API gravity less than 10 degrees. “Tar sands” refers to a formation that has bitumen in it.

As used herein, the term “kerogen” refers to a solid, insoluble hydrocarbon that principally contains carbon, hydrogen, nitrogen, oxygen, and sulfur.

As used herein, the term “bitumen” refers to a non-crystalline solid or viscous hydrocarbon material that is substantially soluble in carbon disulfide.

As used herein, the term “oil” refers to a fluid containing primarily a mixture of condensable hydrocarbons.

As used herein, the term “subsurface” refers to geologic strata occurring below the earth's surface. Similarly, the term “formation” refers to any definable subsurface region. The formation may contain one or more hydrocarbon-containing layers, one or more non-hydrocarbon containing layers, an overburden, and/or an underburden of any geologic formation. An “overburden” and/or an “underburden” is geological material above or below the formation of interest.

An overburden or underburden may include one or more different types of substantially impermeable materials. For example, overburden and/or underburden may include sandstone, shale, mudstone, or wet/tight carbonate (i.e., an impermeable carbonate without hydrocarbons). An overburden and/or an underburden may include a hydrocarbon-containing layer that is relatively impermeable. In some cases, the overburden and/or underburden may be permeable.

As used herein, the term “organic-rich rock” refers to any rock matrix holding solid hydrocarbons and/or heavy hydrocarbons. Rock matrices may include, but are not limited to, sedimentary rocks, shales, siltstones, sands, silicilytes, carbonates, and diatomites. Organic-rich rock may contain kerogen or bitumen.

As used herein, the term “organic-rich rock formation” refers to any formation containing organic-rich rock. Organic-rich rock formations include, for example, oil shale formations, coal formations, and tar sands formations.

As used herein, the term “pyrolysis” refers to the breaking of chemical bonds through the application of heat. For example, pyrolysis may include transforming a compound into one or more other substances by heat alone or by heat in combination with an oxidant. Pyrolysis may include modifying the nature of the compound by addition of hydrogen atoms which may be obtained from molecular hydrogen, water, carbon dioxide, or carbon monoxide. Heat may be transferred to a section of the formation to cause pyrolysis.

As used herein, the term “electrical formation heating” refers to any technique where electricity is used to increase the temperature of a formation. Examples include the use of electrical heating elements in or near the formation to transmit heat into the surrounding formation, and the generation of electric current passing through formation fractures.

As used herein, the term “enhanced hydrocarbon recovery” refers to any technique for increasing the amount of hydrocarbon fluids that can be extracted from a formation. These may include, for example, gas injection, carbon dioxide injection, steam injection, and water injection.

As used herein, the term “injection system” refers to any collection of fluid processing equipment that compresses, regulates, measures, transports or distributes a fluid for injection into a subsurface formation. Such equipment may include, for example, pumps, compressors, piping, valves, pipelines, coolers, heaters, controls, meters, and injection wells.

As used herein, the term “sequestration” refers to the storing of a fluid that is a by-product of a process rather than discharging the fluid to the atmosphere or open environment. Sequestration is typically done in a subsurface formation or near the bottom of an ocean, but also includes solid storage by reaction of, for example, carbon dioxide with metal oxides to produce stable carbonates.

As used herein, the term “air separation unit” or “ASU” refers to any item of fluid processing equipment that separates atmospheric air, thereby providing two gas streams. One gas stream typically comprises substantially nitrogen, while the other typically comprises substantially oxygen.

As used herein, the terms “rich” and “lean” mean that, of the total amount of carbon dioxide entering a carbon dioxide separation process; at least about 51% of that carbon dioxide exits the separation process via the rich carbon dioxide stream, with the remaining carbon dioxide exiting in the lean carbon dioxide stream. In some embodiments, at least about 75%, or at least about 90%, of the total carbon dioxide entering the separation process exits as the rich carbon dioxide stream.

As used herein, the term “wellbore” refers to a hole in the subsurface made by drilling or insertion of a conduit into the subsurface. A wellbore may have a substantially circular cross section, or other cross-sectional shape (e.g., an oval, a square, a rectangle, a triangle, or other regular or irregular shapes). As used herein, the term “well”, when referring to an opening in the formation, may be used interchangeably with the term “wellbore.”

### DESCRIPTION OF SELECTED SPECIFIC EMBODIMENTS

The inventions are described herein in connection with certain specific embodiments. However, to the extent that the following detailed description is specific to a particular embodiment or a particular use, such is intended to be illustrative only and is not to be construed as limiting the scope of the inventions. Accordingly, the invention is not limited to the specific embodiments described below, but rather, it includes all alternatives, modifications, and equivalents falling within the true spirit and scope of the appended claims.

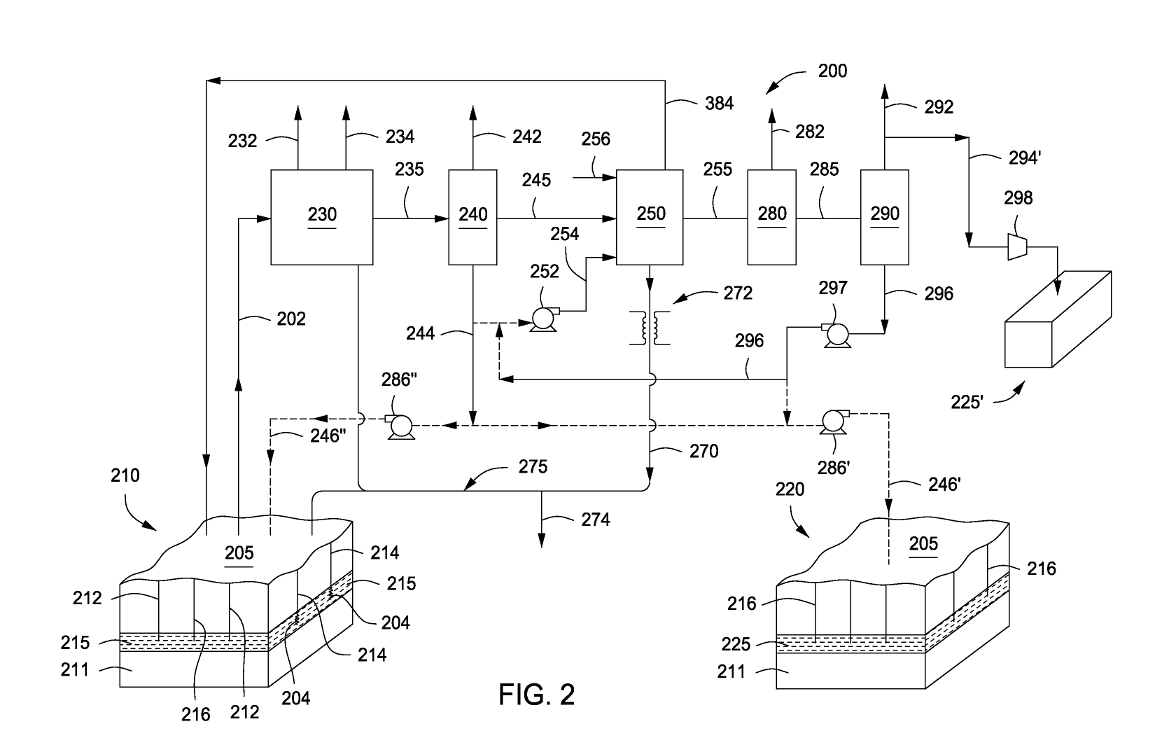

FIG. 2 is a schematic view of a system 200 for low-emission power generation and hydrocarbon recovery of the present invention, in one embodiment. The system 200 exists principally to provide electrical power for heating a subsurface formation containing organic-rich rock. The heating, in turn, enables the flow of hydrocarbon fluids from a subsurface formation to a surface for fluid processing.

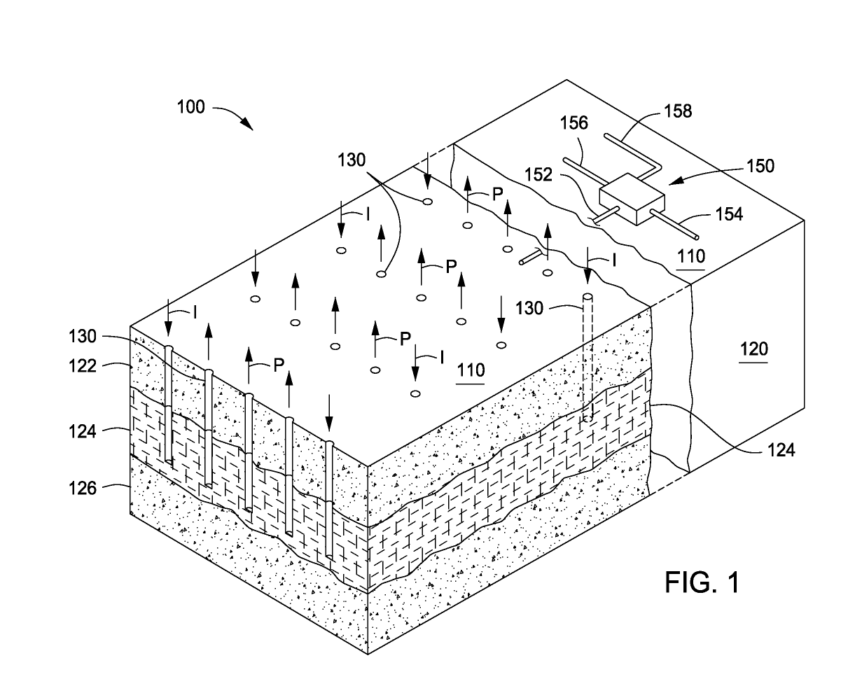

First, a hydrocarbon development area 210 is seen. The hydrocarbon development area 210 is similar to the hydrocarbon development 100 of FIG. 1, described above. In this respect, the hydrocarbon development area 210 has a surface 205. The surface 205 is shown as an earth surface on land; however, the surface 205 may be a seabed under a body of water, such as a lake or an ocean.

The hydrocarbon development area 210 also has a subsurface 211. The subsurface 211 includes various formations, including an organic-rich rock formation 215. The organic-rich rock formation 215 defines a rock matrix having hydrocarbons residing therein. The hydrocarbons may be solid hydrocarbons such as kerogen that are sought to be pyrolyzed. Alternatively, the hydrocarbons may be heavy hydrocarbons such as bitumen that are sought to be mobilized and produced. Thus, the hydrocarbon development area 210 is for the purpose of producing hydrocarbon fluids from the organic-rich rock formation 215 to the surface.

In order to produce hydrocarbon fluids, a plurality of production wells 212 are provided. The production wells 212 are shown as being substantially vertical; however, it is understood that the production wells 212 may be deviated or even horizontal. The production wells 212 are arranged to capture mobilized hydrocarbon fluids and transport them to a fluids separation facility 230 at the surface 205.

In order to produce hydrocarbon fluids to the surface 205, it is necessary to apply heat to the organic-rich rock formation 215. Accordingly, the hydrocarbon development area 210 also includes a plurality of heater wells 214. Each of the heater wells 214 includes an electrically resistive heating element 204. The resistive heating elements 204 may be a metal (or other electrically conducting) rod or a metal (or other electrically conducting) pipe placed within the respective wellbores of the heater wells 214. In this instance, a current is applied through an insulated wire or cable or other suitable conductive medium down to the metal rod or pipe. Alternatively, the resistive heating elements 204 may be electrically conductive proppant. In this instance, the proppant may be placed within the wellbore between two conductive elements, or within the formation itself between two wellbores. Alternatively still, the resistive heating elements 204 may be an actual electric coil. In this instance, the electric coil is placed within the wellbore along the depth of the organic-rich rock formation 215, and receives current from an insulated wire or cable.

It is noted that numerous ways have been disclosed over the years for applying electrically resistive heat in situ, either to accomplish pyrolysis of solid hydrocarbons, or to reduce viscosity of heavy oil such as so-called tar sands. A number of patent documents disclosing just some of those in situ methods are listed above.

One of the patent documents listed above is U.S. Pat. Publ. No. 2010/0101793. That application is entitled “Electrically Conductive Methods For Heating A Subsurface Formation To Convert Organic Matter Into Hydrocarbon Fluids.” The application discloses methods for heating a subsurface formation through the use of an electrically conductive material placed between two wellbores. Such material may be, for example, metallic proppant. This published application represents an attractive option for in situ heating of an organic-rich rock formation, and is incorporated herein in its entirety by reference.

It is noted that the inventions herein are not limited by the specific arrangement for electrically resistive elements unless so stated in the claims.

A separate development area is shown in FIG. 2 at 220. The development area 220 is preferably adjacent or at least near the hydrocarbon development area 210. The development area 220 likewise has the surface 205 and a subsurface 211. The development area 220 further includes a sequestration formation 225. The sequestration formation 225 may be used as part of the system 200 to sequester greenhouse gases such as carbon dioxide. As will be discussed below, carbon dioxide is a by-product of some electrical power generation systems, including the system 200. Accordingly, the capture and sequestration of such by-products is desirable.

Returning to the hydrocarbon development area 210, after heat is applied to the organic-rich rock formation 215 for sufficient time and at sufficient temperatures to enable the flow of hydrocarbon fluids, the hydrocarbon fluids are produced to the surface 205. Production takes place through the production wells 212. From there, the hydrocarbon fluids are transported through one or more flow lines 202 to the fluids separation facility 230.

The fluids separation facility 230 may comprise any known technology for hydrocarbon separation. Examples include, for example: centrifugal separators, gravity separators, refrigerators, adsorptive kinetic separators, or some combination of these processes. Further, the fluids separation facility 230 may employ a counter-current contacting tower that uses a liquid solvent as part of a lean oil absorption process. In this instance, the fluids separation facility 230 will preferably include a liquid solvent regenerator.

The fluids separation facility 230 may also include a filtering component. This serves to remove any fines or particles from the formation 215 entrained in the hydrocarbon flow stream of flow lines 202.

As a result of the processing of the produced hydrocarbon fluids, a hydrocarbon liquids stream 232 is generated. The hydrocarbon liquids stream 232 will comprise heavier hydrocarbons such as propane, butane, pentane, and hexane. The hydrocarbon liquids stream 232 may also include aromatics. The hydrocarbon liquids stream 232 is preferably sent downstream for further processing and sale.

As a further result of the processing of the produced hydrocarbon fluids, a water stream 234 may also be generated. The water stream 234 may optionally be carried through a purification process and then released into the water shed. Alternatively, the water stream 234 may be at least partially treated and then reinjected into either the organic-rich rock formation 215 or a separate subsurface formation such as sequestration formation 225.

As yet a further result of the processing of the produced hydrocarbon fluids, a hydrocarbon gas stream 235 is generated. The hydrocarbon gas stream 235 will comprise non-condensable hydrocarbons, primarily methane, and possibly some ethane or propane. The hydrocarbon gas stream 235 may also include nitrogen and trace amounts of acid gases such as carbon dioxide and hydrogen sulfide. The hydrocarbon gas stream may also include hydrogen, oxygen, and carbon monoxide.

The hydrocarbon gas stream 235 is preferably carried to a gas separation unit 240 for further processing. The further processing is for the purpose of sweetening the gas stream 235 to meet pipeline specifications. For example, the gas separation unit 240 may include cryogenic separation such as the use of a Controlled Freeze Zone™ tower. The gas separation unit 240 may also employ pressure swing absorption, or PSA. PSA processes use adsorption onto a solid sorbent (e.g., silica gel). Some regeneration of beds within pressure vessels will typically be required. The fluids separation facility 230 will accordingly have suitable compressors, valves, and control systems for moving fluids through the vessels. In some instances, multiple beds are provided to optimize fluid processing.

The gas separation unit 240 may alternatively employ either a counter-current contacting tower or a series of co-current contacting vessels that use a liquid solvent as part of an acid gas absorption process. In this instance, the gas separation unit 240 will preferably include a liquid solvent regenerator.

As a result of the gas processing process, a sweetened gas stream is generated. A majority of the sweetened gas stream is sent downstream for commercial sale. This is shown at line 242. In addition, a sour gas stream is released. This is shown at line 244. The sour gas stream 244 comprises primarily carbon dioxide. These sour components are preferably sent through a compressor in an injection system for injection.

In the arrangement of FIG. 2, two separate compressors 286′, 286″ are shown. Compressor 286′ forms a compressed carbon dioxide stream 246′, which is injected into the sequestration formation 225 for sequestration. Compressor 286″ forms a compressed carbon dioxide stream 246″, which is injected into the organic-rich rock formation 215 as part of enhanced hydrocarbon recovery. Carbon dioxide injection wells are shown at 216.

At least a portion of the sweetened gas stream 242 is taken for use in power generation. A sweetened slip stream representing the portion of the sweetened gas stream 242 is shown at line 245. The sweetened slip stream is then used as fuel for a combustion and power generation process. It is understood that stream 245 may also contain liquids used as fuel. Thus, stream 245 may be referred to herein as a fuel stream.

The power generation system 200 includes a fossil fuel power plant 250. The fossil fuel power plant 250 includes a combustor (not shown in FIG. 2) that receives the fuel stream 245 for a combustion process. If the gas processing facility 240 is not used, then the fossil fuel power plant 250 receives the hydrocarbon stream 235 as fuel.

The fossil fuel power plant 250 will also receive an oxygen-containing gas, or oxidant. This is shown at line 256. The oxidant 256 may simply be air. Alternatively, the oxidant 256 will be substantially pure oxygen. In the latter instance, an air separation unit is employed. This provides an oxy-fuel combustion.

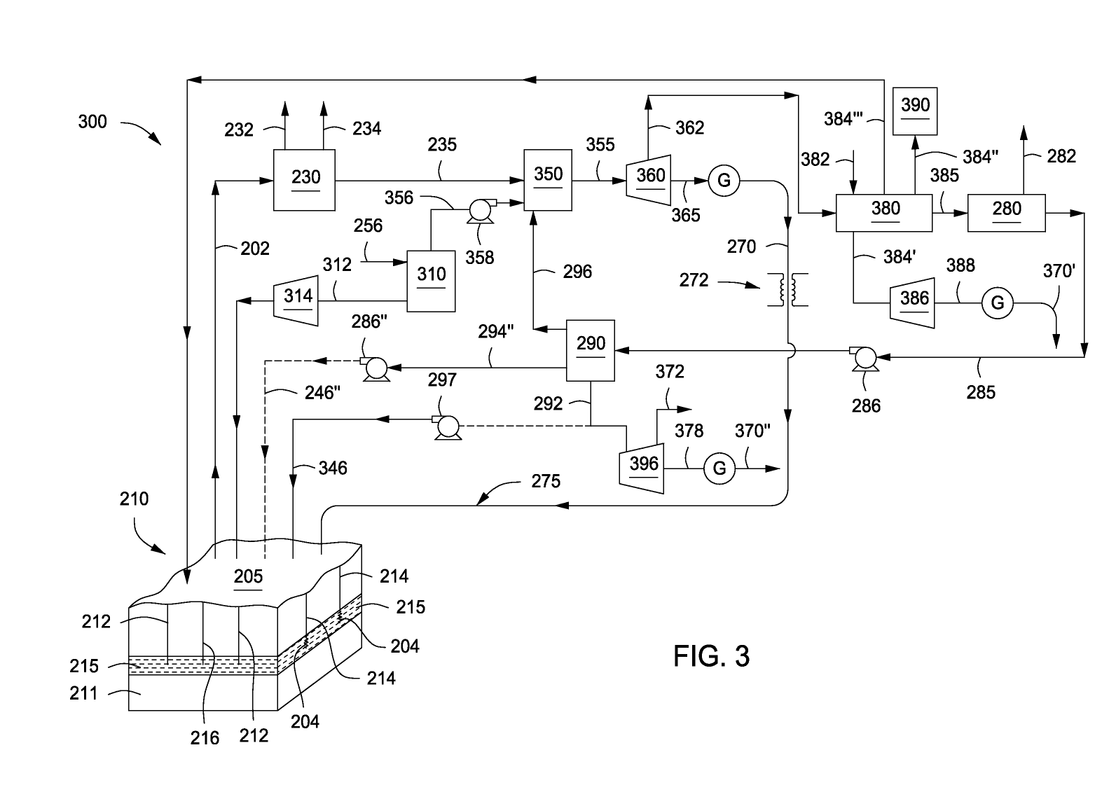

FIG. 3 provides an enlarged schematic view of a portion of the low-emission power generation system 200 of FIG. 2. However, a modified system 300 is provided having additional optional features. The modified power generation system 300 shows the input of air 256 into an air separation unit 310. The air separation unit 310 may employ membranes or may employ a cryogenic process for separating nitrogen and oxygen components.

The cost associated with the air separation unit 310 depends on the desired purity of the products. Producing 99.5% pure O₂ requires a significant increase in capital and horsepower compared to an air separation unit 310 that produces 95% oxygen. Therefore, the purity of the O₂ that is used in oxy-fuel combustion should be limited based on the specification of the products of combustion.

In one aspect, the oxygen purity is below 70%. Such an O₂ stream may contain N₂ levels greater than 20%. At the other end of the spectrum, an air separation unit 310 may be designed for high-purity oxygen production in which even Argon is separated from the O₂, resulting in oxygen purity close to 100%.

Substantially pure oxygen 356 is released from the air separation unit 310. Separated components such as nitrogen are released through line 312. Line 312 may also include trace amounts of carbon dioxide, argon, and neon. The nitrogen 312 may optionally be injected into the sequestration formation 225 or the organic-rich rock formation 215. In the system 300 of FIG. 3, nitrogen in line 312 is passed through a compressor 314, and then injected into the formation 215.

Returning to FIG. 2, the combustor in the fossil fuel power plant 250 will also receive a diluent gas 254. The diluent gas 254 may be, for example, carbon dioxide. In one aspect, the diluent gas 254 is taken as a slip stream from the acid gas stream 244 from the gas separation unit 240. The diluent gas 254 is used for temperature control and mass flow. For example, the diluent gas 254 is used to modulate the temperature of the combustor 250 and to generate a gaseous combustion stream 255. Optionally, a portion of the low-energy gas stream (shown at 296 and discussed below) is used as part or all of the diluent gas 254.

The diluent gas 254 is preferably taken through a compressor 252. Thereafter, the oxidant 256 and the diluent gas 254 are merged with the hydrocarbon gas stream 235 (or with the fuel stream 245). The combination of the oxidant 256 and the fuel gas 245 in the combustor of the fossil fuel power plant 250 maintain a minimum adiabatic flame temperature and flame stability to combust all or nearly all of the oxygen in the combination of gases. Additional information about the heating value of the components and the combination of gases is found in U.S. Pat. Appl. No. 12/919,699 entitled “Low Emission Power Generation and Hydrocarbon Recovery Systems and Methods.” This application was published in 2011 as U.S. Pat. Publ. No. 2011/0000671.

The combustor in the fossil fuel power plant 250 combusts the combination of the fuel stream 245 and the oxidant 256, and also receives the diluent gas stream 254. A gaseous combustion stream 255 is then generated. During operation, a flame produces temperatures for the gaseous combustion stream 255 up to about 2,200° C. Optionally, a cooling gas is introduced to adjust the temperature of the gaseous combustion stream 255 or to form an outer wall around the flame, thereby keeping the wall of the chamber cooler than the flame.

The system 200 operates for the purpose of generating electrical power. In FIG. 2, electricity 270, or electrical power, is sent across a distribution system 275. Where the power generation system 200 is near the hydrocarbon development area 210, the distribution system 275 may simply be a series of buried electrical wires or heavily insulated cables that deliver electricity to the various heat injection wells 214. However, the power generation system 200 may be remote from the hydrocarbon development area 210. In this instance, the electrical distribution system 275 may include poles or towers (not shown) with suspended lines. In addition, the electrical distribution system 275 may include a transformer 272 for transforming at least a portion of the transmitted electrical power up or down to a final voltage at the hydrocarbon development area 210 for delivery to the one or more resistive heating elements 204 in the heat injection wells 214. Alternatively, the method may further include distributing at least a portion of the transmitted electrical power 270 directly to the one or more resistive heating elements 204. For example, the preferred voltage for the heating elements 204 may be up to 100 kV. The optimal transmission voltage would depend on several factors, including the distance between the fossil fuel power plant and the heating elements, and could range from about 400 V to 800 kV.

In some instances, excess electrical power 270 is generated. In this instance, a portion of the electricity 270 may be sold in a local or regional power grid, indicated at arrow 274.

A gaseous exhaust stream 255 is produced from the fossil fuel power plant 250. The gaseous exhaust stream 255 substantially comprises carbon dioxide and vaporized water. In FIG. 2, the gaseous exhaust stream 255 is directed to a cooler 280. The cooler 280 releases cooled carbon dioxide from line 285. The carbon dioxide (and any other exhaust gases) may then be directed through either or both of the compressors 286′, 286″ via lines 296 for formation injection.

It is preferred that some separation of greenhouse gases be carried out. To this end, the system 200 includes a carbon dioxide separation unit 290. The carbon dioxide separation unit 290 may use, for example, a chemical solvent, a physical solvent, an AKS separator, or other known separation means for separating the cooled carbon dioxide in line 285.

A lean CO₂ stream is released in line 292. The lean CO2 may be vented to the atmosphere. Alternatively, the lean CO₂ may be taken through line 294′ to a compressor 298, and then injected into a subsurface formation. The formation may be sequestration formation 225; alternatively, a separate formation 225′ may receive the lean CO₂.

A rich CO₂ stream is released through line 296. The rich CO₂ in line 296 is optionally taken through a compressor 297. Part of the rich CO₂ may then be directed to the compressor 252 for reintroduction to the combustor as part of the diluent 254. Alternatively or in addition, the rich CO₂ in line 296 may be injected into the sequestration formation 225, the organic-rich rock formation 215, or both.

It is one object of the system 200 to reduce greenhouse gas emissions. Accordingly, the carbon dioxide in streams 244 and 296 are injected into the sequestration formation 225, the organic-rich rock formation 215, or both. If taken through compressor 286′, the CO₂ is injected through line 246′; if taken through compressor 286″, the CO₂ is injected through line 246″.

It is noted that the fossil fuel power plant 250 may employ a combustor along with an expander. FIG. 3 presents a system 300 showing a combustor 350 with an expander 360. The combustor 350 may be a standard external combustor that produces a gaseous combustion stream 355 from the oxidant and fuel. If a diluent is used, the diluent is also mixed in the exhaust. Examples of applicable combustor types include an oxyClaus burner, a partial oxidation (POX) burner, an auto-thermal reforming (ATR) burner, a diffusion burner, a lean-premix combustor, and a piloted combustor. Note that each burner type may require some modification to work with a substantially O₂ stream 356.

In the diffusion flame combustor (or “burner”) the fuel and the oxidant mix and combustion takes place simultaneously in the primary combustion zone. Diffusion combustors generate regions of near-stoichiometric fuel/air mixtures where the temperatures are very high. In pre-mix combustors, fuel and air are thoroughly mixed in an initial stage resulting in a uniform, lean, unburned fuel/air mixture that is delivered to a secondary stage where the combustion reaction takes place.

Lean-premix combustors are now common in gas turbines due to lower flame temperatures, which produces lower NOₓ emissions. In the piloted combustor a hot flamed pilot ensures that the lean fuel oxidant mixture surrounding it maintains stable combustion. These piloted combustors are typically used in aircraft engines and for fuels that may not be able to maintain stable combustion on their own.

A typical POₓ burner mixes natural gas with a steam-oxidizing stream in a homogeneous mixture. The addition of steam is not only to moderate the reaction temperature, but also to produce additional hydrogen in the reaction. The partial oxidation process is characterized by a high fuel-to-oxidizer ratio, far beyond the stoichiometric ratio. POₓ is an example of an ultra rich combustion process.

A typical oxyClaus burner comprises multiple sour gas burners surrounding a central start-up burner muffle. Each sour gas burner would include a feed or “lance” from the oxygen stream 256, the diluent stream 254, and the fuel stream 245. The combined feed streams 256, 254, 245 may form a very hot oxygen flame surrounded by a cooler envelope of gas, such as from a control stream (not shown).

In a typical auto-thermal reforming (ATR) process, a mixture of natural gas 245 and oxygen 356 is fed to the combustor 250. Partial oxidation reactions occur in a combustion zone, and then the products pass through a catalyst bed, where reforming reactions occur. The ATR reactor consists of a refractory lined pressure vessel with a burner, a combustion chamber and a catalyst bed. It has a design similar to that of the POX reactor, but also contains a catalyst bed. The produced syngas temperature is about 1,300 Kelvin (K) as compared to 1,650 K for the POₓ reactor. This reduction in the syngas temperature is important because the catalyst does not support higher temperature values. ATR can produce significantly higher H₂ to CO ratios in the syngas, and is also a soot free operation.

In any arrangement, the combustor 350 will typically include several components, such as a combustion chamber, a gas mixing chamber (or atomizer), a burner nozzle, secondary gas inlets, and an outer wall (or shroud). These individual features are known in the art of power engineering, and are not shown. In the system 300, the atomizer and nozzles may be configured to mix the fuel stream 235 with an oxidizing stream comprising the oxygen-containing stream 356 and a diluent in a highly turbulent manner to ensure that a homogeneous mixture is achieved.

To produce inexpensive carbon dioxide, it is desired that the oxygen-containing stream be the high-purity oxygen stream 356 of system 300. If combustion occurs with significant amounts of nitrogen present, then expensive and energy intensive processing equipment would be required to separate the CO₂ from the other gases, such as nitrous oxides (NOₓ). Where carbon dioxide is generated, the CO₂ in line 285 may optionally be sold.

As noted, the system 300 also includes an expander 360. The expander 360 works in conjunction with the combustor 350 to receive the gaseous combustion stream 355. The expander 360 may be a gas powered turbine or a hot gas expander.

Where the expander 360 is a hot gas expander, the expander 360 may be a commercially available unit, such as the FEX or similar model from General Electric. However, the expander 360 may also be a slightly modified unit to handle the gaseous combustion stream 355 at the expected temperatures and pressures. In one exemplary embodiment, a plurality of hot gas expanders are aligned in parallel. The use of a hot gas expander results in increased degrees of freedom to optimize the system for improved performance. For example, the operating pressure may be elevated for increased thermodynamic efficiency of a Brayton power cycle.

In one exemplary embodiment, combustion takes place at higher than atmospheric pressure. In this way, additional power can be produced by expanding the products of combustion across the expander 360 in the Brayton cycle. The efficiency of a Brayton cycle is a function of the pressure ratio across the expander and the inlet temperature to the expander. Therefore, moving to higher-pressure ratios and higher expander inlet temperatures increases gas turbine efficiency.

The inlet temperature to the expander 360 may be limited by material considerations and cooling of the part surfaces. Therefore, some cooling of the gaseous combustion stream 355 may be desired. It is preferred that carbon dioxide be used in place of steam to moderate the temperature. Using steam is expensive and would also result in the formation of additional hydrogen in the products of combustion which is not desired in the present cycle.

It is also noted that for shallow formations that require heating for mobilization of hydrocarbon fluids, formation pressures are relatively low, which means that the system 300 will not be able to take advantage of wellhead pressures but must rely on the compressor 358.

A gaseous combustion stream 355 entering the expander 360 generally comprises carbon dioxide and water vapor. The combustion reaction is shown by the equation below, with the carbon dioxide entering the chamber generally remaining unreacted:

CH₄+2O₂→2H₂O+Co₂

The combustor 350 and the expander 360 may be part of a combined-cycle power plant or a simple-cycle power plant. The power plant may utilize a steam turbine, a combustion turbine, an internal combustion engine, or combinations thereof. The power generation system 300 may also utilize a heat recovery steam generator 380 as part of a conditioning system for gaseous exhaust. Turbines associated with heat expansion and power generation may share a single shaft, or may be arranged in multi-shaft blocks.

The expander 360 generates mechanical power. This is indicated in FIG. 3 as a rotating shaft 365. The shaft 365, in turn, generates electrical power in generator “G.” As a result, electricity 270 is generated as described in connection with FIG. 2.

The electricity 270, or electrical power, is sent across a distribution system 275. Where the power generation system 300 is near the hydrocarbon development area 210, the distribution system 275 may simply be a series of buried electrical wires or heavily insulated cables that deliver electricity to the various heat injection wells 214. However, the power generation system 300 may be remote from the hydrocarbon development area 210. In this instance, the electrical distribution system 275 may include poles or towers (not shown) with suspended lines. In addition, the electrical distribution system 275 may include a transformer 272 for transforming at least a portion of the transmitted electrical power up or down to a final voltage at the hydrocarbon development area 210 for delivery to the one or more resistive heating elements 204 in the heat injection wells 214. Alternatively, the method may further include distributing at least a portion of the transmitted electrical power 270 directly to the one or more resistive heating elements 204 as noted above.

The expander 360 also outputs a gaseous exhaust stream 362. The gaseous exhaust stream 362 substantially comprises carbon dioxide and vaporized water. In FIG. 3, the gaseous exhaust stream 362 is directed to a heat recovery steam generator (HRSG) 380. The HRSG 380 receives feed water 382, and turns the feed water 382 into steam 384 using the heat from the gaseous exhaust stream 362. Thus, the HSRG is a heat recovery unit.

The HRSG 380 generates a steam stream 384′, which may be sent to a steam turbine 386 to generate additional electrical power “G” through shaft 388. Electricity is shown being generated at line 370′. In this way, the heat generated from the expander 360 is more fully utilized.

The electricity from line 370′ may be merged with the distribution system 275 for providing electrical energy for the heating elements 204. Alternatively, and as shown in FIG. 3, at least a portion of the steam from the HRSG 380 may be used to provide heat for a desalinization plant 390. This steam stream is shown at 384″. Alternatively still, a portion of the electricity from line 270 and/or line 370′ may be sold in the local or regional power grid (shown in FIG. 2 at 274).

Optionally, a portion of the steam, shown at line 384′″, may be injected into the organic-rich rock formation 215 as an aid to heating. This would be of particular benefit where the formation 215 contains tar sands. Injection pressure would come from the HRSG 380 itself Injection of steam 384 is also shown in FIG. 2, using heat energy supplied by the fossil fuel power plant 250.

It is noted that steam injection, or steam flooding, is a method commonly used for extracting heavy oil. Two mechanisms are at work to improve the amount of hydrocarbon recovered. The first is a heating of the in situ hydrocarbons to higher temperatures. This serves to decrease the viscosity of the heavy hydrocarbons so that they more easily flow through the formation and toward the producing wells. A second mechanism is the physical displacement of mobilized fluids, meaning that water is pushing hydrocarbons towards the production wells. One form of steam injection is steam assisted gravity drainage, or SAGD. In this method, two horizontal wells are drilled, one a few meters above the other, and steam is injected into the upper well. The intent is to reduce the viscosity of the bitumen to the point where gravity will pull it down into the producing well.

In addition to steam, the HRSG 380 also produces a low-energy or cooled exhaust gas 385. The low-energy exhaust gas 385 is sent to the cooling unit 280. The cooling unit 280 produces a water dropout stream 282. The water dropout stream 282 (shown in both FIGS. 2 and 3) may be used for water injection or water flooding. This is a type of enhanced hydrocarbon recovery where water is injected into a hydrocarbon bearing formation. The water can improve hydrocarbon production by pressure support of the reservoir and by sweeping or displacing the hydrocarbons from the reservoir and towards a production well.

It is noted that where an HSRG 380 is used, the water dropout 282 may be relatively low.

The cooling unit 280 also produces a cooled low-energy gas stream 285. The cooled low-energy gas stream 285 again represents substantially a carbon dioxide stream. The carbon dioxide stream 285 may be sent to a compressor 286, and then directed to the carbon dioxide separation unit 290.

As noted above, it is preferred that some separation of greenhouse gases be carried out. In another embodiment, the compressed cooled gas stream is separated into a rich carbon dioxide stream and a lean carbon dioxide stream. This is provided in a carbon dioxide separation unit. The carbon dioxide separation unit may use, for example, a chemical solvent, a physical solvent, or an adsorptive kinetic separation (or “AKS”) bed.

The carbon dioxide separation unit 290 produces a rich CO₂ stream. The rich stream is released in line 296. The rich CO₂ in line 296 may be directed to the combustor 350 as part of the diluent stream 254. Alternatively or in addition, the rich CO₂ may be directed through line 294″ to the compressor 286″, where it is then injected into the organic-rich rock formation 215. Alternatively or in addition, CO₂ from the carbon dioxide stream 294″ may be sold to a third party.

A lean CO₂ stream is also generated. This is shown in line 292. The lean CO₂ stream of line 292 may be vented to the atmosphere. Alternatively or in addition, the lean CO₂ in line 292 may be directed to a combustor 396, which releases a combustion exhaust gas 372 and also generates mechanical power through illustrative shaft 378. Electricity or electrical power 370″ is generated through electrical generator “G.”

In one aspect, the lean CO₂ in line 292 is fed into an expander to produce (i) mechanical power, and (ii) a lower pressure carbon dioxide lean stream. Electrical power is generated in response to the mechanical power of the expander. A lower pressure lean carbon dioxide stream is optionally released into the atmosphere.

It is again an object of the system 300 to reduce greenhouse gas emissions. Accordingly, the streams 296 and 292 may be injected into the sequestration formation. If taken through compressor 286″, the CO₂ is injected through line 246″; if taken through a separate compressor 297, the CO₂ is injected through line 346.

As can be seen, systems 200, 300 are offered for the integration of power generation, formation heating and oil and gas facilities. The systems 200, 300 integrate power generation technologies to provide power for formation heating and sequestration of gases. After start-up, the systems 200, 300 use the produced hydrocarbons to fuel the power generation for in situ heating.

Alternative embodiments of the systems 200, 300 are possible. In one alternative embodiment, a portion of the water stream 282 may be routed to the HRSG 380 as the water input 382 to generate more steam 384. In another embodiment, the fuel gas stream 245 and the diluent gas stream 254 may be pre-heated to help control combustion stability. This may be done, for example, by heat-exchanging with the gaseous combustion stream 255. In yet another embodiment, hydrogen may be added to the fuel gas stream 245 or the diluent stream 254 as disclosed in U.S. Pat. No. 6,298,652. Alternatively, ethane may be added to the fuel gas stream 245 or to the diluent gas stream 254 to help control combustion stability. Ethane may be purchased separately, or may be provided from hydrocarbon liquids stream 232. Adding ethane or other heavier hydrocarbon fuel may require additional clean up facilities, so the economics of such an approach should be carefully considered.

In some embodiments, at least a portion of the systems 200 or 300 may be located on an offshore barge or platform. In such a system, the power may be utilized offshore or onshore and the formation 215 may also be located in an offshore location.

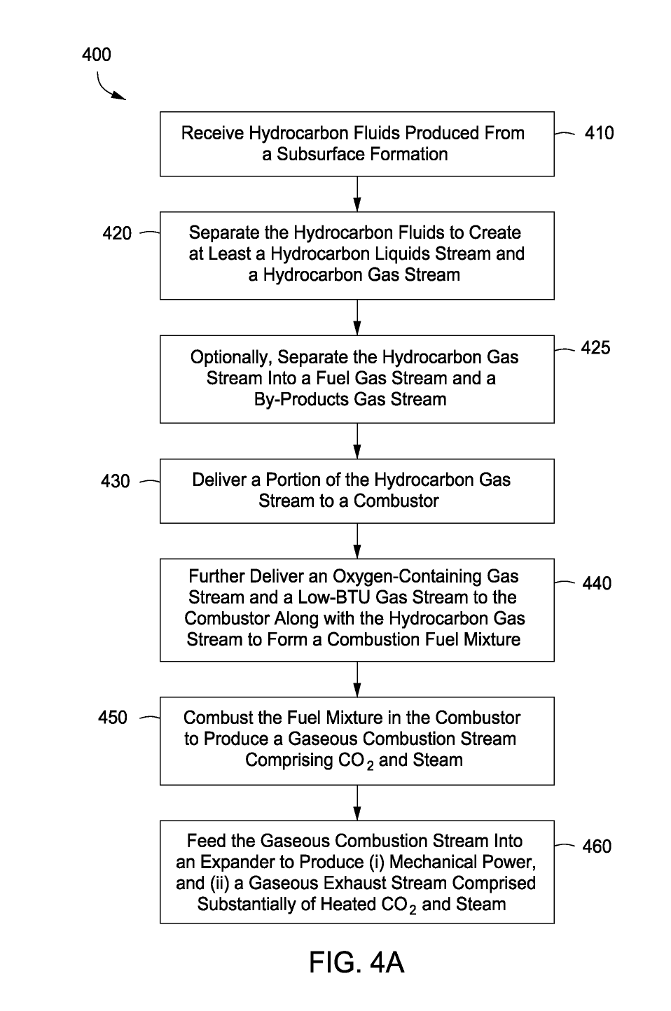

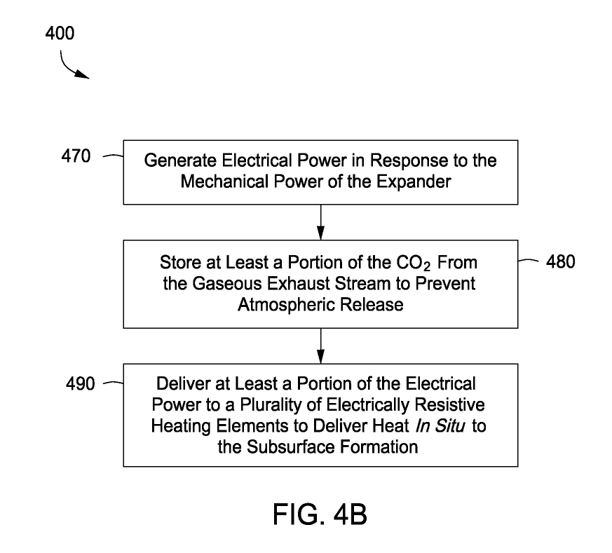

FIGS. 4A and 4B provide an exemplary flow chart relating to the integration of a hydrocarbon production system with a low-emission power generation system, such as the systems 200, 300 of FIGS. 2 and 3. Specifically, a method 400 for in situ heating of a subsurface formation is provided. In the method 400, the subsurface formation comprises organic-rich rock. The organic-rich rock may include, for example, kerogen or bitumen.

The method 400 includes receiving hydrocarbon fluids produced from the subsurface formation. This is shown at Box 410. The hydrocarbon fluids are then separated to create at least a hydrocarbon gas stream and a hydrocarbon liquids stream. This is provided at Box 420. A water stream may optionally also be created.

The method 400 may further include separating the hydrocarbon gas stream into a fuel gas stream and a by-products gas stream. This is seen at Box 425. The fuel gas stream comprises methane, while the by-products gas stream will comprise primarily carbon dioxide, with possibly some sulfurous components, hydrogen, and carbon monoxide.

The method 400 also includes delivering a portion of the hydrocarbon gas stream (such as the fuel gas stream) to a combustor. This is shown at Box 430. In addition, an oxidant stream and a diluent gas stream are directed into the combustor. This is provided at Box 440. The oxygen-containing stream may be substantially pure oxygen generated from an air separation unit, or it may be air. In either aspect, together the hydrocarbon gas stream and the oxygen-containing stream form a combustion mixture. The method then includes combusting the mixture in the combustor to produce a gaseous combustion stream using the diluent stream to reduce the temperature of combustion, the combustor and exhaust gas. This is seen at Box 450.

The gaseous combustion stream generally comprises carbon dioxide and water vapor. The gaseous combustion stream is fed into an expander to produce (i) mechanical power, and (ii) a gaseous exhaust stream comprised substantially of carbon dioxide and steam. This is shown at Box 460. Electricity is then generated in response to the mechanical power of the expander. This is provided at Box 470 of FIG. 4B.

The method 400 also includes storing at least a portion of the carbon dioxide from the gaseous exhaust stream. The storing step is seen at Box 480. Storing the carbon dioxide minimizes atmospheric release. Preferably, storing a portion of the carbon dioxide comprises injecting a substantial portion of the carbon dioxide into the subsurface formation for enhanced hydrocarbon recovery. Alternatively, storing a portion of the carbon dioxide comprises injecting the carbon dioxide component into a separate subsurface formation for enhanced hydrocarbon recovery or for sequestration.

In one embodiment, a portion of the carbon dioxide from the exhaust stream is separated into a rich carbon dioxide stream and a lean carbon dioxide stream. This is provided in a carbon dioxide separation unit. The carbon dioxide separation process may be any suitable process designed to separate the pressurized exhaust gases into a rich carbon dioxide stream and a lean carbon dioxide stream. Ideally, the separation process would segregate all of the greenhouse gases in the exhaust, such as carbon dioxide, CO, NOₓ, SOₓ, etc. in the rich carbon dioxide stream, leaving the remainder of the exhaust components such as nitrogen, oxygen, argon, etc. in the lean carbon dioxide stream. In practice, however, the separation process may not withdraw all of the greenhouse gases from the lean stream, and some non-greenhouse gases may remain in the rich stream.

Any suitable separation process designed to achieve the desired result may be used. Examples of suitable separation processes include, but are not limited to, amine separation, glycol separation, membrane separation, adsorptive kinetic separation, controlled freeze zone separation, and combinations thereof. In one embodiment, the carbon dioxide separator uses a hot potassium carbonate separation. In one or more embodiments of the invention, the separation process operates at elevated pressure (i.e., higher than ambient and approximately the same as the outlet pressure of the compressor) and is configured to keep the lean carbon dioxide stream pressurized. Maintaining pressure on the lean carbon dioxide stream in this manner allows for smaller separation equipment, provides for improved separation effectiveness, and allows further energy extraction from the lean carbon dioxide stream.

The rich carbon dioxide and lean carbon dioxide streams may be used for the same or different purposes. Uses for each stream include injection into hydrocarbon reservoirs for enhanced hydrocarbon recovery, generation of additional power, carbon sequestration or storage, for recycle to the combustion chamber of the turbine to cool the products of combustion down to the material limitations in the expander, for sale, or for venting. The rich carbon dioxide stream may also be vented or flared.

At least a portion of the rich carbon dioxide rich stream is injected into a subsurface zone as part of the storing or injecting step of Box 480. Optionally, at least a portion of the lean carbon dioxide stream is recirculated into the combustor or may be released to the atmosphere. A portion of the lean carbon dioxide stream may optionally also be injected, such as by using a separate injection system.

The method 400 further includes delivering at least a portion of the electrical power to a plurality of electrically resistive heating elements in order to deliver heat to the subsurface formation. This is provided at Box 490. The plurality of electrically resistive heating elements may represent, for example, metal rods, metal pipes, electrically conductive proppants placed downhole, or combinations thereof. In some instances, the conductive proppants placed downhole are injected into the organic-rich rock formation itself to conduct electricity between adjacent wellbores.

Heating the subsurface formation serves to generate hydrocarbon fluids in situ that can be further produced to the surface. Where the organic-rich rock formation comprises kerogen, heating the subsurface formation causes pyrolysis of the kerogen into hydrocarbon fluids. Where the organic-rich rock formation comprises bitumen, heating the subsurface formation causes mobilization of the bitumen into hydrocarbon fluids. Where the organic-rich rock formation comprises bitumen, it is preferred that heating also takes place by delivering at least a portion of the steam from a heat recovery steam generator into the subsurface formation.

In one aspect, all electrical power from the power generator is delivered to the heating elements. Alternatively, a portion of the electrical power is delivered to an item of oil and gas fluids processing equipment, such as a compressor, a pump, a separator, a blower, a fan, a crusher, a conveyor, a centrifuge, or a monitoring system.

In addition, a portion of the electrical power may be delivered into a local or regional power grid, or may be sent to electrical components of a desalinization plant.

It is preferred that conditioning of the gaseous exhaust stream generated from the expansion step of Box 460 take place. Such conditioning may include cooling of the gaseous exhaust stream.

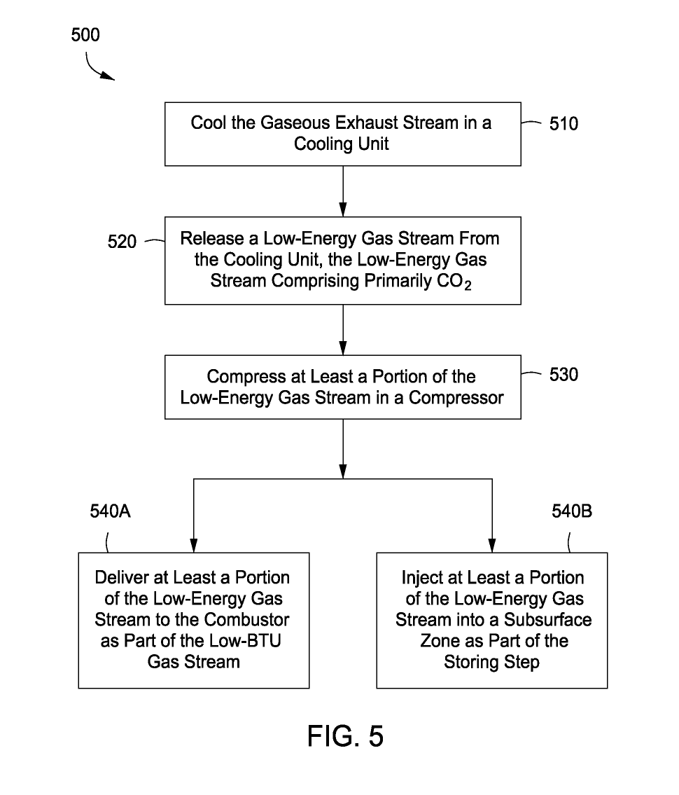

FIG. 5 is a flow chart showing steps for a method 500 of conditioning the gaseous exhaust stream generated in the method 400 of FIGS. 4A and 4B, in certain embodiments. First, the gaseous exhaust stream is cooled in a cooling unit. This is shown at Box 510.

The method 500 also includes releasing a low-energy gas stream from the cooling unit. This is provided at Box 520. The low-energy gas stream comprises primarily carbon dioxide.

The method 500 further includes compressing at least a portion of the low-energy gas stream in a compressor. This is indicated at Box 530. From there, at least a portion of the low-energy gas stream may be redirected to the combustor as part of the diluent gas stream. This is seen at Box 540A. Alternatively or in addition, at least a portion of the low-energy gas stream is injected into a subsurface zone as part of the storing step of Box 480. The subsurface zone may be the heated subsurface formation, in which case the carbon dioxide is used for enhanced hydrocarbon recovery. Alternatively, the subsurface zone is a separate subsurface formation provided for enhanced hydrocarbon recovery or for sequestration.

Embodiments of the presently disclosed systems and methods may be used to produce low-emission electric power for formation heating. Some of the CO₂ from the air separation processes and the cooling process is injected into a subsurface formation for sequestration, while some may be mixed with oxygen and hydrocarbon fuel gas, combusted, and then expanded, to produce electric power. Additional power may also be produced by heat recovery from the exhaust gases from the hot gas (or other) expander in a condensing steam cycle such as through the use of a heat recovery steam generator (HRSG). Since the products of stoichiometric combustion are only CO₂ and water, a high purity carbon dioxide stream can be produced by cooling the flue gas and condensing the water out of the stream. The result of this process is the production of power and the manufacturing of additional carbon dioxide.

The methods for low emission power generation herein involve the use of produced hydrocarbon fluids for providing a combustible fuel in a fossil fuel power generation process. The term “fossil fuel power generation process” refers to any process of reacting a fuel derived from a carbon-containing material, with an oxidizer to generate electricity and an exhaust stream containing carbon dioxide. Examples include a generator driven by a simple-cycle gas turbine, combined-cycle gas turbine generators, oxy-fuel gas turbines, stoichiometric gas turbines, and reciprocating engines. Another example is the use of generators driven by steam turbines and associated boilers. The fossil fuel power generation processes may optionally provide hot process steam or heat.

In the present methods, the carbon-containing materials may include any form of natural gas, oil, kerosene, diesel, coal, and bitumen that can be used as a fuel or upgraded into a fuel.

While the present invention may be susceptible to various modifications and alternative forms, the exemplary embodiments discussed above have been shown only by way of example. However, it should again be understood that the invention is not intended to be limited to the particular embodiments disclosed herein. Indeed, the present invention includes all alternatives, modifications, and equivalents falling within the true spirit and scope of the appended claims.

What is claimed is:

1. A method for in situ heating of a subsurface formation, the formation comprising organic-rich rock, and the method comprising:
receiving produced fluids from the subsurface formation;
processing the produced fluids to generate a hydrocarbon stream;
combusting a portion of the hydrocarbon stream at a fossil fuel power plant to generate electrical power, and to release an exhaust stream comprising carbon dioxide;
injecting at least a portion of the exhaust stream into a subsurface zone, thereby reducing atmospheric release; and
using at least a portion of the electrical power for electrical formation heating of the subsurface formation.

2. The method of claim 1, wherein:
processing the produced fluids comprises separating the hydrocarbon stream to create at least a hydrocarbon liquid stream and a hydrocarbon gas stream; and
wherein combusting a portion of the hydrocarbon stream comprises combusting the hydrocarbon gas stream.

3. The method of claim 1, wherein combusting a portion of the hydrocarbon stream comprises:
delivering a portion of the hydrocarbon stream to a combustor;
directing an oxidant stream to the combustor along with the hydrocarbon stream to form a combustible mixture;
directing a diluent gas stream to at least one combustor to reduce the temperature of the combustor and the exhaust stream;
combusting the mixture in the combustor to produce a gaseous combustion stream;
feeding the gaseous combustion stream into an expander to produce (i) mechanical power, and (ii) a lower pressure gaseous exhaust stream comprised substantially of heated carbon dioxide and water vapor; and
generating the electrical power in response to the mechanical power of the expander.

4. The method of claim 1, further comprising:
separating at least a portion of the exhaust stream from the fossil fuel power plant into a rich carbon dioxide stream and a lean carbon dioxide stream in a carbon dioxide separation unit; and
wherein injecting at least a portion of the exhaust stream into a subsurface zone comprises injecting at least a portion of the rich carbon dioxide rich stream into the subsurface zone for enhanced hydrocarbon recovery, for sequestration, or for both.

5. The method of claim 4, further comprising:
(i) injecting at least a portion of the lean carbon dioxide stream into the subsurface zone for enhanced hydrocarbon recovery, for sequestration, or for both; or
(ii) releasing the lean carbon dioxide stream to the atmosphere.

6. The method of claim 1, wherein using at least a portion of the electrical power for electrical formation heating comprises delivering at least a portion of the electrical power to a plurality of electrically resistive heating elements in order to deliver heat in situ to the subsurface formation.

7. The method of claim 1, wherein:
the subsurface formation comprises kerogen;
delivering heat to the subsurface formation causes pyrolysis of kerogen into hydrocarbon fluids; and
the method further comprises producing at least a portion of the hydrocarbon fluids to the surface as the produced fluids.

8. The method of claim 1, wherein:
the subsurface formation comprises bitumen or oil;
delivering heat to the subsurface formation causes mobilization of the bitumen or oil; and
the method further comprises producing mobilized bitumen or oil to the surface as the produced fluids.

9. The method of claim 1, wherein the subsurface zone is also the subsurface formation from which produced fluids have been produced.

10. The method of claim 1, wherein injecting the portion of the exhaust stream into the subsurface zone comprises injecting carbon dioxide for enhanced hydrocarbon recovery or for sequestration.

11. The method of claim 3, further comprising:
cooling the expander exhaust stream in a cooling unit.

12. The method of claim 11, further comprising:
releasing a low-energy gas stream from the cooling unit, the low-energy gas stream comprising primarily carbon dioxide; and
compressing at least a portion of the low-energy gas stream in a compressor.

13. The method of claim 11, further comprising:
compressing at least a portion of the low-energy gas stream in a compressor; and
delivering at least a portion of the compressed cooled gas stream to the combustor as part of the diluent gas stream.

14. The method of claim 11, further comprising:
injecting at least a portion of the compressed cooled gas stream into the subsurface zone.

15. The method of claim 12, further comprising:
separating at least a portion of the low-energy gas stream into a rich carbon dioxide stream and lean carbon dioxide stream in a carbon dioxide separation unit; and
injecting at least a portion of the rich carbon dioxide rich stream into a subsurface zone for enhanced hydrocarbon recovery, for sequestration, or for both.

16. The method of claim 15, further comprising:
(i) injecting at least a portion of the lean carbon dioxide stream into the subsurface zone for enhanced hydrocarbon recovery, for sequestration, or for both; or
(ii) releasing the lean carbon dioxide stream to the atmosphere.

17. The method of claim 15, further comprising:
feeding the lean carbon dioxide stream into an expander to produce (i) mechanical power, and (ii) a lower pressure carbon dioxide lean stream;
generating electrical power in response to the mechanical power of the expander; and
releasing the lower pressure carbon dioxide lean stream into the atmosphere.

18. The method of claim 16, wherein the subsurface zone (i) is the heated subsurface formation or (ii) is a separate subsurface formation provided for enhanced hydrocarbon recovery or sequestration.

19. The method of claim 1, further comprising:
(i) delivering a portion of the electrical power to an item of oil and gas fluids processing equipment, (ii) delivering a portion of the electrical power into a local or regional power grid, or (iii) both.

20. The method of claim 19, wherein the item of oil and gas fluids processing facility comprises a separator, a pump, a crusher, a conveyor, a centrifuge, a blower, a fan, a monitoring system, a compressor, or combinations thereof.

21. The method of claim 1, further comprising:
directing the exhaust stream to a heat recovery unit;
heating steam in the heat recovery unit; and
using heat energy from the steam to generate electricity.

22. The method of claim 21, further comprising:
delivering at least a portion of the electricity from the heat energy of the steam to a plurality of electrically resistive heating elements in order to deliver heat in situ to the subsurface formation for the electrical formation heating.

23. The method of claim 21, further comprising:
using at least a portion of the heat energy from the steam to heat water in a desalinization plant.

24. The method of claim 20, further comprising:
delivering at least a portion of the steam from the heat recovery unit to the subsurface formation for steam injection.

25. The method of claim 1, wherein:
the produced fluids are produced from wells at a hydrocarbon development area; and
the method further comprises:
generating high-voltage electricity for transmission of electrical power for more efficient transmission of the electrical power to the hydrocarbon development area.

26. The method of claim 25, further comprising:
transforming at least a portion of the electrical power up or down to a final voltage at the hydrocarbon development area for delivery to the one or more resistive heating elements.

27. The method of claim 25, further comprising:
distributing at least a portion of the transmitted electrical power directly to the one or more resistive heating elements without transforming the electrical power.

28. The method of claim 1, further comprising:
cooling the exhaust stream in a cooling unit; and
releasing condensed water from the cooling unit.

29. The method of claim 28, further comprising:
pumping the released water in a pump; and
injecting the water into a subsurface zone.

30. The method of claim 29, wherein the subsurface zone (i) is the heated subsurface formation, and the water is used for enhanced hydrocarbon recovery, or (ii) is a separate subsurface formation provided for enhanced hydrocarbon recovery or sequestration.

31. The method of claim 1, wherein combusting a portion of the hydrocarbon stream at a fossil fuel power plant comprises:
delivering a portion of the hydrocarbon stream to a combustor; and
directing an oxidant stream to the combustor along with the hydrocarbon stream to form a combustible mixture, wherein the oxidant stream is comprised primarily of oxygen.

32. The method of claim 31, further comprising:
separating air into at least one lean oxygen stream and one rich oxygen stream in an air separation unit;
releasing at least portion of the lean oxygen stream into the atmosphere; and
wherein the oxidant stream is comprised of at least a portion of the rich oxygen stream.

33. The method of claim 30, further comprising:
injecting at least a portion of the lean oxygen stream into the subsurface zone.

34. The method of claim 33, wherein the subsurface zone (i) is the heated subsurface formation, or (ii) is a separate subsurface zone provided for enhanced hydrocarbon recovery or sequestration.

35. The method of claim 1, wherein combusting a portion of the hydrocarbon gas stream at a fossil fuel power plant comprises:
delivering a portion of the hydrocarbon stream to a combustor; and
directing an oxidant stream to the combustor along with the hydrocarbon stream to form a combustible mixture, wherein the oxidant stream is comprised primarily of air.

36. The method of claim 6, wherein the plurality of electrically resistive heating elements comprises electrically conducting rods, electrically conducting pipes, electrically conductive proppant, or combinations thereof.

37. The method of claim 3, further comprising:
separating the hydrocarbon gas stream into a fuel gas stream and a by-products gas stream; and
wherein delivering a portion of the hydrocarbon gas stream to a combustor comprises:
compressing the fuel gas stream, and
delivering the fuel gas stream into the combustor.

38. A low-emission power generation system for in situ heating of a subsurface formation, comprising:
an organic-rich rock formation residing below an earth surface;
a plurality of electrically resistive heating elements located within the organic-rich rock formation;
a plurality of production wells configured to produce hydrocarbon fluids at the earth surface;
a hydrocarbon separation facility configured to separate the produced hydrocarbon fluids into at least a hydrocarbon gas stream and a hydrocarbon liquids stream;
a combustor configured to combust at least a portion of the hydrocarbon stream with an oxygen-containing stream to output a gaseous combustion stream;
an expander configured to receive the gaseous combustion stream and produce (i) mechanical power, and (ii) a gaseous exhaust stream comprised of carbon dioxide and steam;
a cooling system configured to cool the gaseous exhaust stream and to separate any condensed liquids from the gaseous exhaust stream;
a compressor configured to pressurize at least a portion of the cooled exhaust stream from the cooling system for delivery of at least a portion of the pressurized exhaust stream to a first injection system for injection into a subsurface zone;
a power generator for generating electricity in response to the mechanical power of the expander; and
an electricity transmission system configured to distribute at least a portion of the electricity to the plurality of electrically resistive heating elements.

39. The power generation system of claim 38, wherein the plurality of electrically resistive heating elements comprises electrically conducting rods, electrically conducting pipes, electrically conductive proppant, or combinations thereof.

40. The power generation system of claim 38, wherein the organic-rich rock comprises kerogen.

41. The power generation system of claim 38, wherein the organic-rich rock comprises bitumen.

42. The power generation system of claim 38, wherein the combustor is further configured to receive a diluent gas stream to reduce the temperature of the combustor and the gaseous combustion stream.

43. The power generation system of claim 42, further comprising:
a carbon dioxide separation unit configured to separate a portion of the pressurized exhaust stream from the compressor into a rich carbon dioxide stream and a lean carbon dioxide stream; and
wherein the rich carbon dioxide stream is directed to the first injection system for injection into a subsurface zone, the lean carbon dioxide stream is released to the atmosphere, and any remaining un-separated portion of the pressurized exhaust stream is used as the diluent gas stream.

44. The power generation system of claim 43, further comprising:
a second injection system configured to inject at least a portion of the lean carbon dioxide stream from the carbon dioxide separation unit into a subsurface zone.

45. The power generation system of claim 42, further comprising:
a carbon dioxide separation unit configured to separate at least a portion of the exhaust stream from the expander into a rich carbon dioxide stream and a lean carbon dioxide stream; and
wherein the rich carbon dioxide stream is directed to the first injection system for injection into a subsurface zone, and the lean carbon dioxide stream is released to the atmosphere.

46. The power generation system of claim 39, wherein the cooling system further comprises a heat recovery steam generator, wherein the heat recovery steam generator is configured to cool the gaseous exhaust stream and boil water, and release a heated steam stream and a cooled low-energy gas stream.

47. The power generation system of claim 46, further comprising:
a steam turbine for converting heat energy from the steam to electricity.

48. The power generation system of claim 46, further comprising:
a compressor configured to receive at least a portion of the steam from the heat recovery steam generator for delivery to an injection system for injection into the organic-rich rock formation.

49. The power generation system of claim 39, wherein:
the power generator is one or more electrical generators; and
the electricity transmission system further comprises a transformer for stepping up or down voltage of the electricity before distributing the electricity to the plurality of electrically resistive heating elements.

50. The power generation system of claim 38, wherein the combustor is part of a power plant comprising a steam turbine, a combustion turbine, an internal combustion engine, or combinations thereof.

51. The power generation system of claim 38, wherein the oxygen-containing stream comprises primarily oxygen.

52. The power generation system of claim 51, wherein:
the power generation system further comprises an air separation unit; and
the oxygen-containing stream is provided by the air separation unit.

53. The power generation system of claim 52, wherein:
the air separation unit is configured to release a by-products stream comprising nitrogen; and
the system further comprises an injection system configured to receive the by-products stream and deliver the by-products stream to the injection system for injection into the subsurface zone.

54. The power generation system of claim 39, wherein the oxygen-containing stream comprises air.

55. The power generation system of claim 39, further comprising:
a gas separation unit for separating the hydrocarbon gas stream into a fuel stream and a by-products gas stream; and
wherein the portion of the hydrocarbon gas stream combusted in the combustor comprises the fuel stream.
